(19) United States
(12) Patent Application Publication
(10) Pub. No.: US 2025/0216209 A1
(43) Pub. Date: Jul. 3, 2025

(54) METHOD AND SYSTEM FOR CHARGING STATION RECOMMENDATION

(71) Applicant: HYUNDAI AUTOEVER CORP., Seoul (KR)

(72) Inventor: Lam LEE, Seoul (KR)

(21) Appl. No.: 18/959,972

(22) Filed: Nov. 26, 2024

(30) Foreign Application Priority Data
Dec. 27, 2023 (KR) 10-2023-0193051

(51) Int. Cl. G01C 21/34; B60L 58/12

(52) U.S. Cl. CPC G01C 21/3469; B60L 58/12; B60L 2240/62; B60L 2240/72; B60L 2250/16; B60L 2260/52

(57) ABSTRACT

Methods and systems for recommending a charging station are described. According to one embodiment, a method comprises obtaining a charging amount of a mobility apparatus, obtaining a distance to empty (DTE) using the charging amount, obtaining a driving level using the charging amount, obtaining a first charging station existing within the DTE and surrounding data of the first charging station, and determining the first charging station or a second charging station existing within the DTE as a recommended charging station using the driving level and an analysis result of the surrounding data of the first charging station.

### CROSS-REFERENCE TO RELATED APPLICATION

This application claims priority from Korean Patent Application No. 10-2023-0193051 filed on Dec. 27, 2023 in the Korean Intellectual Property Office, and all the benefits accruing therefrom under 35 U.S.C. 119, the contents of which in its entirety are herein incorporated by reference.

### BACKGROUND

### 1. Field

The present disclosure relates to a method and system for charging station recommendation, and more particularly, to a method for relieving driving anxiety of a user by providing a route to a charging station highly likely to stably perform charging to the user, and a system for performing the same.

### 2. Description of the Related Art

A navigation service may compare a charging amount expected to be required for a mobility apparatus to arrive at a destination with a charging state of the mobility apparatus, and may select a charging station according to an optimal charging station recommendation logic and provide the selected charging station to the mobility apparatus when it is decided that the mobility apparatus will not be able to arrive at the destination only with a current charging amount. The purpose of the navigation service for recommending a charging station is to relieve driving anxiety of a mobility apparatus driver by easily coping with an unexpected situation such as insufficiency of a charging amount while the mobility apparatus arrives at the destination.

A recent optimal charging station recommendation logic selects a charging station by utilizing whether or not real-time charging is possible, charging station position information, whether or not the charging station is opened, operating hour information, and the like, as static/dynamic data, and a recent navigation service provides the selected charging station to the mobility apparatus driver.

However, an existing charging station recommendation logic comprehensively considers various attributes of chargers, routes, and the like, but is a logic exposed to an error, with limitations in current infrastructure network and static/dynamic charging station information, such as a real-time information-related communication error/outlier, insufficiency of real-time management, and insufficiency of static data management, and there is a limitation in adopting a recommended charging station.

Accordingly, it has been required to provide a logic that notifies the mobility apparatus driver of a charging station in consideration of a charging station high likely to stably perform charging.

### SUMMARY

Aspects of the present disclosure provide a system for charging station recommendation capable of allowing a mobility apparatus to arrive at the next charging station before a charging amount of the mobility apparatus is completely depleted when a charging-impossible situation at the destination charging station is identified after the mobility apparatuses arrives at the destination charging station.

Aspects of the present disclosure also provide a system for determining data to be reflected in determining a charging station to be recommended as a destination to a mobility apparatus user based on a charging amount of a mobility apparatus.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, there is a method for charging station recommendation. The method for charging station recommendation being performed by a navigation device, comprising obtaining a charging amount of a mobility apparatus, obtaining a distance to empty (DTE) using the charging amount, obtaining a driving level using the charging amount, obtaining a first charging station existing within the distance to empty (DTE) and surrounding data of the first charging station, and determining any one of the first charging station and a second charging station existing within the distance to empty (DTE) as a recommended charging station using the driving level and an analysis result of the surrounding data of the first charging station.

In some embodiments, the surrounding data of the first charging station may include adjacent charging station data of the first charging station, and an adjacent charging station of the first charging station is a charging station existing within a predefined distance from the first charging station.

In some embodiments, the obtaining of the distance to empty (DTE) using the charging amount may include obtaining a destination of the mobility apparatus, and ending charging station recommendation when the destination exists within the distance to empty (DTE).

In some embodiments, the obtaining of the driving level using the charging amount may include determining the driving level as level A when the charging amount is greater than or equal to a first reference that is predefined, and ending charging station recommendation.

In some embodiments, the determining of any one of the first charging station and the second charging station existing within the distance to empty (DTE) as the recommended charging station using the driving level and the analysis result of the surrounding data of the first charging station may include determining the driving level as level B when the charging amount is less than the first reference and greater than or equal to a second reference that is predefined, and determining a charging station which has more rapid chargers and whose last use point in time is closer to an expected use point in time as an analysis result of surrounding data, of the first charging station and the second charging station existing within the distance to empty (DTE), as the recommended charging station.

In some embodiments, the surrounding data may include distance data between the recommended charging station and an adjacent charging station.

In some embodiments, the surrounding data may include an adjacent charging station of the recommended charging station and route data on a route for arriving at the adjacent charging station on a traveling route of the mobility apparatus.

In some embodiments, the determining of any one of the first charging station and the second charging station existing within the distance to empty (DTE) as the recommended charging station using the driving level and the analysis result of the surrounding data of the first charging station may include determining the driving level as level C when the charging amount is less than a second reference that is predefined, and determining a charging station whose last use point in time of an adjacent charging station is closer to an expected use point in time as an analysis result of surrounding data, of the first charging station and the second charging station, as the recommended charging station.

In some embodiments, the surrounding data, may include route data on a route for arriving at an adjacent charging station from the recommended charging station.

According to an aspect of the present disclosure, there is a method for charging station recommendation, the method being performed by a navigation device. The method for charging station recommendation comprising: identifying a re-departure situation of a mobility apparatus after the mobility apparatus arrives at a first charging station, deciding whether or not charging has been unsuccessful when the re-departure situation is identified and automatically displaying recommendation information on an adjacent charging station other than the first charging station when it is decided that charging has been unsuccessful as a decision result.

In some embodiments, the identifying of the re-departure situation of the mobility apparatus after the mobility apparatus arrives at the first charging station may include obtaining a time when the mobility apparatus has entered a first recommended charging station and a time when the mobility apparatus has exited from the first recommended charging station, and the deciding of whether or not the charging has been unsuccessful when the re-departure situation is identified includes deciding that charging in the first charging station has been unsuccessful when an interval between the time when the mobility apparatus has entered the first recommended charging station and the time when the mobility apparatus has exited from the first recommended charging station is less than a predefined time.

In some embodiments, the deciding of that the charging in the first charging station has been unsuccessful when the interval between the time when the mobility apparatus has entered the first recommended charging station and the time when the mobility apparatus has exited from the first recommended charging station is less than the predefined time may include obtaining door opening data of a driver's seat, and deciding that the first charging station is unavailable when door opening has been sensed between the time when the mobility apparatus has entered the first recommended charging station and the time when the mobility apparatus has exited from the first recommended charging station.

In some embodiments, the identifying of the re-departure situation of the mobility apparatus after the mobility apparatus arrives at the first charging station may include obtaining a charging amount of the mobility apparatus that has entered the first recommended charging station and a charging amount of the mobility apparatus that has exited from the first recommended charging station, and the deciding of whether or not the charging has been unsuccessful when the re-departure situation is identified includes deciding that charging in the first charging station has been unsuccessful when the charging amount of the mobility apparatus that has entered the first recommended charging station and the charging amount of the mobility apparatus that has exited from the first recommended charging station are the same as each other.

In some embodiments, the automatic displaying of the recommendation information on the adjacent charging station other than the first charging station may include transmitting a fault report for the first recommended charging station to a server.

In some embodiments, the transmitting of the fault report for the first recommended charging station to the server may include obtaining a request for selecting the recommendation information on the adjacent charging station other than the first charging station, and transmitting the fault report for the first recommended charging station to the server when the request for selecting the recommendation information on the adjacent charging station other than the first charging station is obtained.

According to an aspect of the present disclosure, there is a system for charging station recommendation, comprising a communication interface, a memory into which a computer program is loaded, and one or more processors executing the computer program, The system for charging station recommendation being performed by a computer program performs an instruction for obtaining a charging amount of a mobility apparatus, an instruction for obtaining a distance to empty (DTE) using the charging amount, an instruction for obtaining a driving level using the charging amount, an instruction for obtaining a first charging station existing within the distance to empty (DTE) and surrounding data of the first charging station, an instruction for determining any one of the first charging station and a second charging station existing within the distance to empty (DTE) as a recommended charging station using the driving level and an analysis result of the surrounding data of the first charging station, and an instruction for requesting a route having the determined recommended charging station as a destination from a server.

In some embodiments, the instruction for obtaining the distance to empty (DTE) using the charging amount may include, an instruction for obtaining a destination of the mobility apparatus, and an instruction for ending charging station recommendation when the destination exists within the distance to empty (DTE).

In some embodiments, the instruction for obtaining the driving level using the charging amount may include, an instruction for determining the driving level as level A when the charging amount is greater than or equal to a first reference that is predefined, and an instruction for ending charging station recommendation.

In some embodiments, the instruction for determining any one of the first charging station and the second charging station existing within the distance to empty (DTE) as the recommended charging station using the driving level and the analysis result of the surrounding data of the first charging station may include an instruction for determining the driving level as level B when the charging amount is less than the first reference and greater than or equal to a second reference that is predefined, and an instruction for determining a charging station which has more rapid chargers and whose last use point in time is closer to an expected use point in time as an analysis result of surrounding data, of the first charging station and the second charging station existing within the distance to empty (DTE), as the recommended charging station.

In some embodiments, the instruction for determining any one of the first charging station and the second charging station existing within the distance to empty (DTE) as the recommended charging station using the driving level and the analysis result of the surrounding data of the first charging station may include an instruction for determining the driving level as level C when the charging amount is less than a second reference that is predefined, and an instruction for determining a charging station whose last use point in time of an adjacent charging station is closer to an expected use point in time as an analysis result of surrounding data, of the first charging station and the second charging station, as the recommended charging station.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a configuration diagram of a system for charging station recommendation according to an exemplary embodiment of the present disclosure;

FIGS. 2 to 6 are flowcharts illustrating processes for charging station recommendation that are performed;

FIGS. 7 and 8 are illustrative diagrams for describing a method for selecting a charging station to be recommended;

FIGS. 9 and 10 are illustrative diagrams illustrating a navigation screen providing a service for charging station recommendation; and

FIG. 11 is an illustrative hardware configuration diagram of the system for charging station recommendation according to some exemplary embodiments of the present disclosure.

### DETAILED DESCRIPTION

Hereinafter, preferred embodiments of the present disclosure will be described with reference to the attached drawings. The advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, some embodiments of the present disclosure will be described in detail with reference to the accompanying drawings.

A mobility apparatus according to some exemplary embodiments of the present disclosure may be any one of an automobile, a locomotive, an electric vehicle, an autonomous vehicle, a bicycle, a shared electric scooter, and an unmanned aerial vehicle (UAV). In addition, power used by the mobility apparatus may be electric power.

Hereinafter, various exemplary embodiments of the present disclosure will be described with reference to the accompanying drawings.

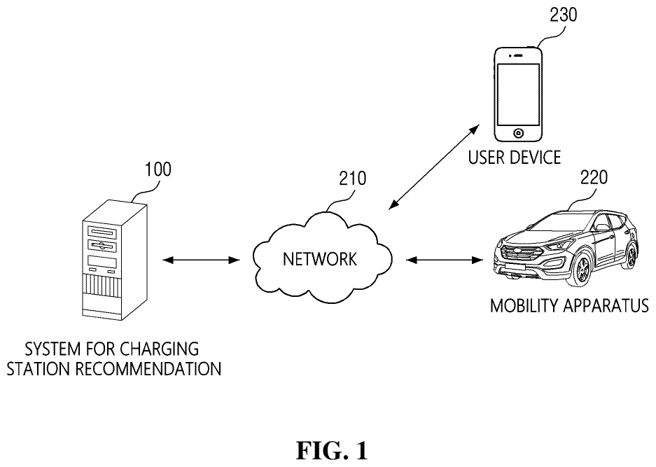

FIG. 1 is a configuration diagram of a system for charging station recommendation according to an exemplary embodiment of the present disclosure. As illustrated in FIG. 1, a system 100 for charging station recommendation may be connected to a mobility apparatus 220 through a network 210 to obtain a charging amount from the mobility apparatus 220. The system 100 for charging station recommendation may obtain a distance to empty (DTE) and a driving level of the mobility apparatus 220 based on the obtained charging amount.

The system 100 for charging station recommendation may be connected to a user device 230 through a network 210 to obtain a destination from the user device 230. The system 100 for charging station recommendation determines a charging station to be recommended to the mobility apparatus in consideration of comprehensive consideration of various attributes of chargers included in charging stations, routes, and the like, but determines a recommended charging station with a logic exposed to an error, with limitations in current infrastructure network and static/dynamic charging station information, such as a real-time information-related communication error/outlier, insufficiency of real-time management, and insufficiency of static data management, and thus, the mobility apparatus arriving at the charging station determined by the system 100 for charging station recommendation may not be able to perform charging.

Accordingly, the system 100 for charging station recommendation may determine a charging station with many charging stations in the vicinity or a charging station with many charging stations highly likely to perform charging as the charging station to be recommended to the mobility apparatus in order to cope with a case where the mobility apparatus arriving at the charging station determined by the system 100 for charging station recommendation is not able to perform the charging

The system 100 for charging station recommendation may be connected to the user device 230 through the network 210 to obtain a selection as to whether or not to automatically recommend a charging station according to a charging amount from the user device 230, and may provide a recommended charging station determined based on the charging amount of the mobility apparatus to the user device 230 when the selection as to whether or not to automatically recommend the charging station according to the charging amount is obtained.

The system 100 for charging station recommendation may be connected to the user device 230 through the network 210 to obtain the selection as to whether or not to automatically recommend the charging station according to the charging amount from the user device 230, may periodically obtain the charging amount of the mobility apparatus when a non-selection as to whether or not to automatically recommend the charging station according to the charging amount is obtained, and may obtain an opinion by popping up the selection as to whether or not to automatically recommend the charging station according to the charging amount on the user device again when a driving level obtained based on the obtained charging amount of the mobility apparatus is level B or level C.

The user device 230 may be a navigation device built into the mobility apparatus 220 or a mobile terminal such as a smartphone in which a navigation application is installed. The user device 230 linked with the mobility apparatus 220 may perform an operation of obtaining the selection on whether to recommend the charging station according to the charging amount. The system 100 for charging station recommendation may provide a route for arriving at the recommended charging station to a user through the user device 230 linked with the mobility apparatus 220.

The system 100 for charging station recommendation may obtain the distance to empty (DTE) based on the charging amount of the mobility apparatus 220. The system 100 for charging station recommendation may end charging station recommendation when a destination exists within the distance to empty (DTE).

The system 100 for charging station recommendation may obtain the driving level based on the charging amount of the mobility apparatus 220. The system 100 for charging station recommendation may determine the driving level as level A when the charging amount of the mobility apparatus 220 is greater than or equal to a first reference that is predefined. The system 100 for charging station recommendation may determine the driving level as level B when the charging amount of the mobility apparatus 220 is less than the first reference and greater than or equal to a second reference. The system 100 for charging station recommendation may determine the driving level as level C when the charging amount of the mobility apparatus 220 is less than the second reference that is predefined.

The system 100 for charging station recommendation may end the charging station recommendation when it determines the driving level as level A. The system 100 for charging station recommendation may provide a route to the destination to the user device 230 when it determines the driving level as level A. The system 100 for charging station recommendation may repeat an operation of obtaining the charging amount of the mobility apparatus 220 at a predefined cycle and obtaining the driving level when it determines the driving level as level A. The system 100 for charging station recommendation that has determined the driving level as level A may select and provide a charging station that does not deviate from the route by a predefined distance or more as the recommended charging station when a distance to the destination is very long. The system 100 for charging station recommendation that ends the charging station recommendation in a case of the mobility apparatus 220 whose charging amount is sufficient may generate an effect of providing a driving route without separate excessive data transmission/reception and calculation processes.

The system 100 for charging station recommendation may obtain one or more charging stations existing within the distance to empty (DTE) and obtain surrounding data including position data, charger data, and history data of the one or more charging stations to determine a recommended charging station, when it determines the driving level as level B. The position data of the one or more charging stations may include distance data between the recommended charging station and an adjacent charging station. The system 100 for charging station recommendation may determine the recommended charging station in consideration of a distance between an existing route and the recommended charging station and a distance between the recommended charging station and the adjacent charging station when it determines the driving level as level B. The system 100 for charging station recommendation that recommends the charging station in a case of the mobility apparatus 220 whose charging amount is insufficient but is not in an emergency situation may generate an effect of providing a route that will minimize a driving time while reliably performing charging.

The surrounding data of the charging station includes position data including a position of the charging station on a navigation screen, charger data including a model of the charger included in the charging station, history data including charging station use and use times of vehicles that have entered and have exited from the charging station, and adjacent charging station data including surrounding data of the charging station and charging stations existing within a predefined distance from the charging station.

The system 100 for charging station recommendation may obtain one or more charging stations existing within the distance to empty (DTE) and obtain surrounding data including position data and history data of the one or more charging stations to determine a recommended charging station, when it determines the driving level as level C. The position data of the one or more charging stations may include route data on routes for arriving at the recommended charging station and an adjacent charging station. The system 100 for charging station recommendation may determine the recommended charging station in consideration of routes of the recommended charging station and the adjacent charging station when it determines the driving level as level C. The system 100 for charging station recommendation that recommends the charging station in a case of the mobility apparatus 220 whose charging amount is in an emergency situation may generate an effect of providing a route that will most quickly and reliably perform charging.

When the charging station recommended by the system 100 for charging station recommendation is decided to be a charging-impossible charging station, the system 100 for charging station recommendation may notify the user device 230 of another charging station. The system 100 for charging station recommendation may obtain a time when the mobility apparatus 220 has entered the charging station and a time when the mobility apparatus 220 has exited from the charging station, and may decide that the corresponding charging station may not be used and provide position and route data of the next charging station that the mobility apparatus may reach most quickly from the corresponding charging station to the user device 230 when an interval between such two times is less than a predefined time.

The system 100 for charging station recommendation may obtain a charging amount of the mobility apparatus 200 that has entered the charging station and a charging amount of the mobility apparatus 200 that has exited from the charging station, and may decide that the corresponding charging station may not be used and provide position and route data of the next charging station that the mobility apparatus may reach most quickly from the corresponding charging station to the user device 230 when such two charging amounts are the same as each other.

According to some exemplary embodiments of the present disclosure, the user device 230 obtaining the charging station provided by the system 100 for charging station recommendation may provide a driving experience in which driving anxiety does not exist to the user.

However, this is only an example, and respective examples will be described in more detail with reference to the following drawings.

A processing system according to the present exemplary embodiment may include the system 100 for charging station recommendation. The system 100 for charging station recommendation may be composed of one or more computing apparatuses. For example, the system 100 for charging station recommendation may be composed of one or more cloud compute instances. That is, the system 100 for charging station recommendation may be composed of at least some compute instances of one or more virtual machines and one or more containers. In addition, the system 100 for charging station recommendation may be configured to include both an on-premise physical server and the cloud compute instances. For example, in consideration of a situation where a text with high security requirements should be processed, a module analyzing an input text or at least temporarily storing the input text is implemented on an on-premise physical server positioned in an internal network blocked from the Internet by a firewall, and other modules may be configured using the cloud compute instances.

Hereinabove, the configurations and the operations of the processing system according to an exemplary embodiment of the present disclosure have been described with reference to FIG. 1. An operating method of the system 100 for charging station recommendation of the processing system according to the present disclosure may be understood in more detail with reference to other exemplary embodiments to be described later. In addition, a technical idea that may be understood through the above-described exemplary embodiments of the processing system according to the present exemplary embodiment may be reflected in other exemplary embodiments to be described later even though not specified separately.

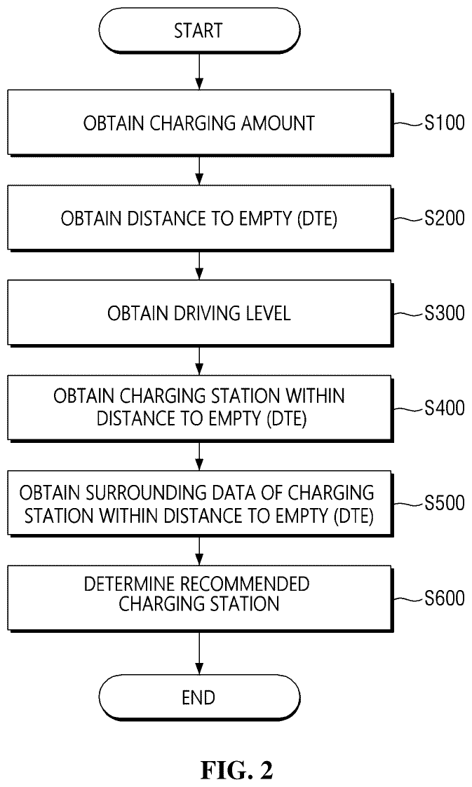

A method for charging station recommendation according to another exemplary embodiment of the present disclosure will be described with reference to FIG. 2. FIGS. 2 to 6 are flowcharts for describing processes of a method for charging station recommendation. The method for charging station recommendation according to the present exemplary embodiment may be performed by one or more computing systems.

In addition, some operations of the method for charging station recommendation according to the present exemplary embodiment may be performed by a first computing apparatus, and the other operations of the method for charging station recommendation according to the present exemplary embodiment may be performed by a second computing apparatus. For example, some operations of the method for charging station recommendation according to the present exemplary embodiment may be performed by an on-premise physical server, and the other operations of the method for charging station recommendation according to the present exemplary embodiment may be performed by a cloud compute instance. Hereinafter, it will be understood that when a subject performing each operation is omitted, the subject is the computing system.

First, in S100, the system for charging station recommendation may obtain the charging amount of the mobility apparatus. The charging amount of the mobility apparatus is an amount of power charged in the mobility apparatus at an obtainment time, and the mobility apparatuses may drive by different distances with the same charging amount depending on types thereof.

Accordingly, next, the system for charging station recommendation may obtain the distance to empty (DTE) in S200. The system for charging station recommendation may stop the charging station recommendation when a distance to the destination is included within the distance to empty (DTE). The system for charging station recommendation may generate an effect of providing a driving route without separate excessive data transmission/reception and calculation processes when the mobility apparatus may arrive at the destination only with a current charging amount.

Next, the system for charging station recommendation may obtain the driving level in S300. The system for charging station recommendation may determine the driving level based on the charging amount of the mobility apparatus. The system for charging station recommendation may determine the driving level as level A when the charging amount of the mobility apparatus is greater than or equal to the first reference that is predefined, determine the driving level as level B when the charging amount of the mobility apparatus is less than the first reference that is predefined and greater than or equal to the second reference, and determine the driving level as level C when the charging amount of the mobility apparatus is less than the second reference that is predefined.

Specifically, the system for charging station recommendation may end the charging station recommendation when it determines the driving level as level A. The system for charging station recommendation may provide the route to the destination to the user device when it determines the driving level as level A. The system for charging station recommendation may repeat an operation of obtaining the charging amount of the mobility apparatus at a predefined cycle and obtaining the driving level when it determines the driving level as level A. The system for charging station recommendation that has determined the driving level as level A may select and provide a charging station that does not deviate from the route by a predefined distance or more as the recommended charging station when a distance to the destination is very long. The system for charging station recommendation that ends the charging station recommendation in a case of the mobility apparatus whose charging amount is sufficient may generate an effect of providing a driving route without separate excessive data transmission/reception and calculation processes.

The system for charging station recommendation may generate an effect of providing a route that will minimize a driving time while reliably performing charging by deciding that the mobility apparatus is a mobility apparatus whose charging amount is insufficient but is not in an emergency situation when it determines the driving level as level B.

The system for charging station recommendation may generate an effect of providing a route that will most quickly and reliably perform charging by deciding that the mobility apparatus is a mobility apparatus whose charging amount is in an emergency situation when it determines the driving level as level C.

Next, the system for charging station recommendation may obtain a charging station within the distance to empty (DTE) in S400. The number of charging station within the distance to empty (DTE) may be one or more. The system for charging station recommendation may obtain all charging stations existing within the distance to empty (DTE), compare all charging stations with each other, select a charging station currently most suitable for the mobility apparatus, and provide a route to the selected charging station to the user device.

Next, the system for charging station recommendation may obtain surrounding data of the charging station within the distance to empty (DTE) in S500. The surrounding data of the charging station may include position data, charger data, and history data of charging stations including charging stations around the charging station, and the position data may include distance data between the charging station and an adjacent charging station around the charging station and route data from the charging station toward the adjacent charging station around the charging station.

Next, the system for charging station recommendation may determine a recommended charging station in S600. The finally recommended charging station may be decided to be a charging station currently most suitable for the mobility apparatus based on the position data, the charger data, and the history data of the charging stations including the charging stations around the charging station, and may be provided to the user device.

The system for charging station recommendation may select a first charging station decided to be the most suitable for being recommended as the recommended charging station, decide whether or not the first charging station does not meet a condition, and select a second charging station decided to be the second most suitable for being recommended as the recommended charging station and provide the second charging station to the user device when it is decided that the first charging station does not meet the condition.

The system for charging station recommendation may select the first charging station decided to be the most suitable for being recommended as the recommended charging station and provide the first charging station to the user device, and may select the second charging station decided to be the second most suitable for being recommended as the recommended charging station and provide the second charging station to the user device when it is decided that the user who has arrived at the first charging station may not use the first charging station.

The system for charging station recommendation that determines and recommends the charging station based on the charging amount of the mobility apparatus and the surrounding data of the charging station may generate an effect of providing a driving route in which data transmission/reception and calculation processes as small as possible are consumed, providing a driving route in which an additional driving time due to charging is minimized, or providing a confirmed charging experience when the charging amount is an emergent level according to a current situation of the mobility apparatus.

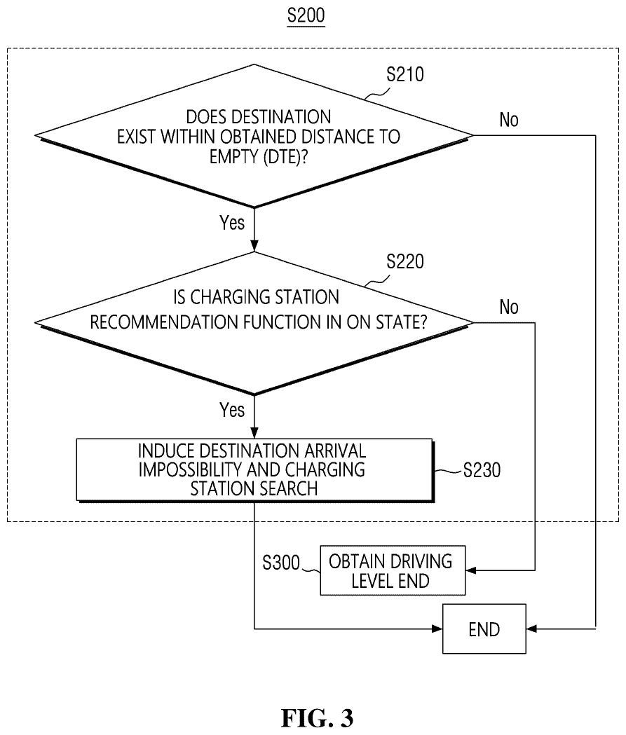

Next, the obtaining (S200) of the distance to empty (DTE) will be described in more detail with reference to FIG. 3.

First, in S210, the system for charging station recommendation may decide whether or not a destination exists within the obtained distance to empty (DTE). The system for charging station recommendation may stop the charging station recommendation without performing separate charging when the destination exists within the obtained distance to empty (DTE). The system for charging station recommendation may generate an effect of providing a driving route without separate excessive data transmission/reception and calculation processes when the mobility apparatus may arrive at the destination only with a current charging amount.

Next, in S220, the system for charging station recommendation may confirm whether or not a charging station recommendation function is in an ON state when the destination does not exist within the obtained distance to empty (DTE). The system for charging station recommendation may not perform a charging station recommendation operation even when the mobility apparatus may not arrive at the destination only with the current charging amount, according to an ON/OFF state of the charging station recommendation function obtained from the user.

The system for charging station recommendation may perform the obtaining (S300) of the driving level when the charging station recommendation function is in the ON state. The system for charging station recommendation may perform inducing destination arrival impossibility and a charging station search (S230) when the charging station recommendation function is in an OFF state. The user who has received the induction for the destination arrival impossibility and the charging station search from the system for charging station recommendation may change the charging station recommendation function to the ON state or perform the charging station search.

The system for charging station recommendation may perform the obtaining (S300) of the driving level when the charging station recommendation function is changed to the ON state. Alternatively, the system for charging station recommendation may set the charging station searched and selected by the user as the destination and provide a route for arriving at the charging station to the user.

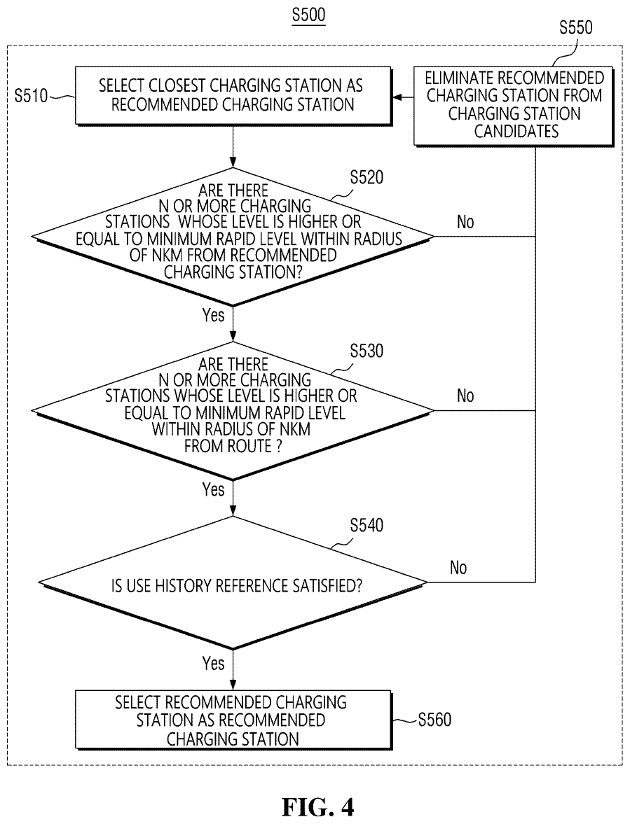

Next, another exemplary embodiment of determining a recommended charging station when the driving level is level B will be described with reference to FIG. 4.

First, in S510, the system for charging station recommendation may select the closest charging station of charging stations within the distance to empty (DTE) as the recommended charging station. When the recommended charging station selected as the closest charging station by the system for charging station recommendation is used, it is possible to consume data transmission/reception and calculation processes as small, and it is possible to provide a driving route in which an additional driving time due to charging is minimized. Accordingly, it may be first decided whether or not the closest charging station is suitable, the closest charging station may be used when the closest charging station is suitable, the second closest charging station may be selected as the recommended charging station when the closest charging station is not suitable, and it may be decided whether or not the second closest charging station is suitable.

Next, in S520, it may be decided whether or not there are N or more chargers whose level is higher or equal to a minimum rapid level within a radius of Nkm from the recommended charging station. Next, in S530, it may be decided whether or not a recommended charging station decided to exist within the radius of Nkm from the recommended charging station and to have the N or more chargers whose level is higher than or equal to the minimum rapid level is positioned around the route. Next, in S550, a recommended charging station decided to exist within the radius of Nkm from the recommended charging station and not to have the N or more chargers whose level is higher than or equal to the minimum rapid level may be eliminated from recommended charging station candidates.

Next, in S530, it may be decided whether or not the recommended charging station exists within a radius of Kkm from an existing traveling route and has N or more chargers whose level is higher or equal to a minimum rapid level. Next, in S540, it may be decided whether or not the recommended charging station decided to exist within the radius of Nkm from the existing traveling route and to have the N or more chargers whose level is higher than or equal to the minimum rapid level satisfies a history reference. Next, in S550, the recommended charging station decided to exist within the radius of Nkm from the existing traveling route and not to have the N or more chargers whose level is higher than or equal to the minimum rapid level may be eliminated from the recommended charging station candidates.

Next, in S540, it may be decided whether or not the recommended charging station satisfies a use history reference. The use history may be derived using the most recent use time and the number of times of use of chargers included in the recommended charging station and the adjacent charging station. For example, when the most recent use date of the chargers included in the recommended charging station and the adjacent charging station exceeds 3 days, it may be decided that these charging stations do not satisfy the use history reference. Alternatively, when the number of times of use of the chargers included in the recommended charging station and the adjacent charging station were used is less than 3 for 7 days, it may be decided that these charging stations do not satisfy the use history reference. The charging station decided not to satisfy the use history reference is a charging station decided to include a charger that may be in a faulty state.

Next, in S560, the recommended charging station decided to satisfy the use history reference may be selected as a recommended charging station. Next, in S550, the recommended charging station decided not to satisfy the use history reference may be eliminated from the recommended charging station candidates.

When the recommended charging station is eliminated from the recommended charging station candidates in S550, the system for charging station recommendation may select the closest charging station of the charging stations excluding the eliminated charging station among the charging stations within the distance to empty (DTE) as the recommended charging station. The system for charging station recommendation may decide whether or not the closest charging station of the charging stations excluding the eliminated charging station is included in the reference and select the closest charging station included in the reference as the recommended charging station.

Next, in S560, the system for charging station recommendation may determine the charging station selected as the recommended charging station as the recommended charging station and provide a route to the determined charging station the user device.

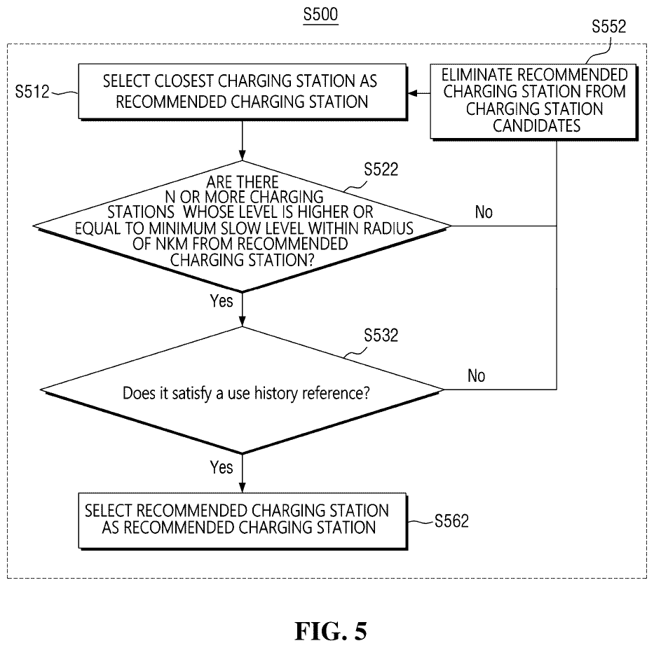

Next, another exemplary embodiment of determining a recommended charging station when the driving level is level C will be described with reference to FIG. 5.

First, in S512, the system for charging station recommendation may select the closest charging station of charging stations within the distance to empty (DTE) as the recommended charging station. When the recommended charging station selected as the closest charging station by the system for charging station recommendation is used, it is possible to consume data transmission/reception and calculation processes as small, and it is possible to provide a driving route in which an additional driving time due to charging is minimized. Accordingly, it may be first decided whether or not the closest charging station is suitable, the closest charging station may be used when the closest charging station is suitable, the second closest charging station may be selected as the recommended charging station when the closest charging station is not suitable, and it may be decided whether or not the second closest charging station is suitable.

Next, in S522, it may be decided whether or not there are N or more chargers within a radius of Nkm from the recommended charging station. Next, in S532, it may be decided whether or not a recommended charging station decided to exist within the radius of Nkm from the recommended charging station and to have the N or more chargers satisfies a history reference. Next, in S552, a recommended charging station decided not to have an adjacent charging station within the radius of Nkm from the recommended charging station may be eliminated from recommended charging station candidates.

Since a charging amount of the mobility apparatus whose driving level is level C is in the emergency situation, a charging station that reliably performs charging regardless of a model of the charger and is closest may be provided as the recommended charging station.

Next, in S532, it may be decided whether or not the recommended charging station satisfies a use history reference. The use history may be derived using the most recent use time and the number of times of use of chargers included in the recommended charging station and the adjacent charging station. For example, when the most recent use date of the chargers included in the recommended charging station and the adjacent charging station exceeds 3 days, it may be decided that these charging stations do not satisfy the use history reference. Alternatively, when the number of times of use of the chargers included in the recommended charging station and the adjacent charging station were used is less than 3 for 7 days, it may be decided that these charging stations do not satisfy the use history reference. The charging station decided not to satisfy the use history reference is a charging station decided to include a charger that may be in a faulty state.

Next, in S562, the recommended charging station decided to satisfy the use history reference may be selected as a recommended charging station. Next, in S552, the recommended charging station decided not to satisfy the use history reference may be eliminated from the recommended charging station candidates.

When the recommended charging station is eliminated from the recommended charging station candidates in S552, the system for charging station recommendation may select the closest charging station of the charging stations excluding the eliminated charging station among the charging stations within the distance to empty (DTE) as the recommended charging station. The system for charging station recommendation may decide whether or not the closest charging station of the charging stations excluding the eliminated charging station is included in the reference and select the closest charging station included in the reference as the recommended charging station.

Next, in S562, the system for charging station recommendation may determine the charging station selected as the recommended charging station as the recommended charging station and provide a route to the determined charging station the user device.

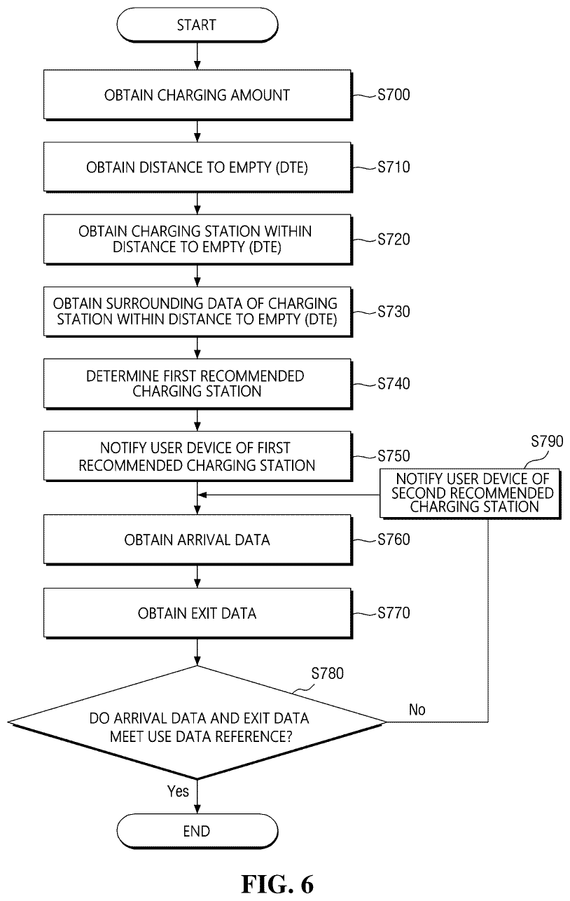

Next, an exemplary embodiment in which when a user who has actually arrived at a charging station recommended by the system for charging station recommendation fails to charge the mobility apparatus, the system for charging station recommendation solves the failure of the charging by providing an adjacent charging station will be described with reference to FIG. 6.

First, in S700, the system for charging station recommendation may be connected to the mobility apparatus through the network to obtain the charging amount from the mobility apparatus. The charging amount obtained from the mobility apparatus is an amount of power charged in the mobility apparatus at an obtainment time, the mobility apparatuses may drive by different distances with the same charging amount depending on types thereof, and the same type of mobility apparatus may drive by different distances with the same charging amount depending on a driving environment.

Next, in S710, the system for charging station recommendation may obtain the distant to empty (DTE) from the charging amount obtained from the mobility apparatus. The system for charging station recommendation may stop the charging station recommendation when a distance to the destination is included within the distance to empty (DTE). The system for charging station recommendation may generate an effect of providing a driving route without separate excessive data transmission/reception and calculation processes when the mobility apparatus may arrive at the destination only with a current charging amount.

Next, in S720, the system for charging station recommendation may obtain one or more charging stations existing within the distance to empty (DTE). The system for charging station recommendation may obtain all charging stations existing within the distance to empty (DTE), compare all charging stations with each other, select a charging station currently most suitable for the mobility apparatus, and provide a route to the selected charging station to the user device. For example, the system for charging station recommendation may provide a charging station that is closest to a route to the destination to shorten a charging time the most to the user device. Alternatively, the system for charging station recommendation may provide a charging station most likely to include a charger that may be used immediately when the mobility apparatus arrives at the charging station to the user device.

Next, in S730, the system for charging station recommendation may obtain surrounding data of charging stations within the distance to empty (DTE). The system for charging station recommendation may compare the surrounding data of the charging stations existing within the distance to empty (DTE) with each other, select a charging station currently most suitable for the mobility apparatus, and provide a route to the selected charging station to the user device.

For example, the system for charging station recommendation may provide a charging station around which an adjacent charging station that the mobility apparatus reaches most quickly exists to the user device when a situation in which the recommended charging station may not be used occurs. Alternatively, the system for charging station recommendation may provide a charging station around which an adjacent charging station that may be used most reliably exists to the user device when a situation in which the recommended charging station may not be used occurs.

Next, in S740, the system for charging station recommendation may determine a first recommended charging station closest to an existing driving route, having an adjacent charging station including a rapid charger, or having an adjacent charging station guaranteeing reliable charging to be notified as the most preferential charging station.

Next, in S750, the system for charging station recommendation may notify the user device of the determined first recommended charging station. The system for charging station recommendation may provide a route to the first recommended charging station to the user through the user device.

Next, the system for charging station recommendation may decide whether charging has been successful or unsuccessful after the mobility apparatus arrives at the charging station. The system for charging station recommendation may decide whether or not the charging has been unsuccessful when a re-departure situation is identified, and may recommend an adjacent charging station as a second charging station or obtain whether or not to recommend the adjacent charging station from the user when not the charging has been unsuccessful as a decision result.

The system for charging station recommendation may obtain arrival data at the first recommended charging station in S760. The arrival data at the first recommended charging station may include a time when the mobility apparatus has entered the charging station and a charging amount of the mobility apparatus that has entered the charging station.

Next, the system for charging station recommendation may obtain exit data from the first recommended charging station in S770. The exit data from the first recommended charging station may include a time when the mobility apparatus has exited from the charging station and a charging amount of the mobility apparatus that has exited from the charging station.

Next, the system for charging station recommendation may decide that the arrival data and the exit data meet use data reference in S780 and end the charging station recommendation operation. The arrival data and the exit data decided to meet the use data reference may be data when the time when the mobility apparatus has entered the charging station and the time when the mobility apparatus has exited from the charging station are obtained and an interval between such two times is a predefined time or more. The arrival data and the exit data decided to meet the use data reference may be data when the charging amount of the mobility apparatus that has entered the charging station and the charging amount of the mobility apparatus that has exited from the charging station are obtained and an interval between such two charging amounts is a predefined interval or more.

The system for charging station recommendation may decide that the charging has been unsuccessful only when door opening data of a driver's seat is obtained between an entry time and an exit time of the mobility apparatus. By reflecting the door opening data in the decision that the charging has been unsuccessful to reflect that the user does not exit the mobility apparatus from the charging station due to a change of his/her mind and obviously attempts the charging but the charging has been unsuccessful, it is possible to reliably perform the charging station recommendation.

The system for charging station recommendation may decide that the charging has been unsuccessful only when a recommendation request for an adjacent charging station is obtained from the user. By reflecting the occurrence of the recommendation request for the adjacent charging station from the user in the decision that the charging has been unsuccessful to reflect that the user does not exit the mobility apparatus from the charging station due to the change of his/her mind and obviously attempts the charging but the charging has been unsuccessful, it is possible to reliably perform the charging station recommendation.

Next, the system for charging station recommendation may decide that the arrival data and the exit data do not meet use data reference in S780 and perform a second recommended charging station recommendation operation in S790. The arrival data and the exit data decided not to meet the use data reference may be data when the time when the mobility apparatus has entered the charging station and the time when the mobility apparatus has exited from the charging station are obtained and the interval between such two times is less than the predefined time. The arrival data and the exit data decided not to meet the use data reference may be data when the charging amount of the mobility apparatus that has entered the charging station and the charging amount of the mobility apparatus that has exited from the charging station are obtained and the interval between such two charging amounts is less than the predefined interval.

The system for charging station recommendation deciding that the arrival data and the exit data do not meet use data reference and performing the second recommended charging station recommendation operation in S790 may determine a charging station that is closest to a route to the destination to shorten a charging time the most, a charging station most likely to include a charger that may be used immediately when the mobility apparatus arrives at the charging station, or a charging station that the mobility apparatus may reach most quickly among adjacent charging stations of the first charging station as a second charging station.

Next, the system for charging station recommendation that has determined the second recommended charging station may notify the user device of the determined second recommended charging station. The system for charging station recommendation that has notified the user device of the second recommended charging station may perform an operation of obtaining arrival data at the second recommended charging station and exit data from the second recommended charging station and deciding whether or not the arrival data at the second recommended charging station and the exit data from the second recommended charging station meet a use data reference.

The system for charging station recommendation may end the charging station recommendation operation when it is decided that the arrival data at the second recommended charging station and the exit data from the second recommended charging station meet the use data reference, and may repeat an operation of recommending the next recommended charging station when it is decided that the arrival data at the second recommended charging station and the exit data from the second recommended charging station do not meet the use data reference.

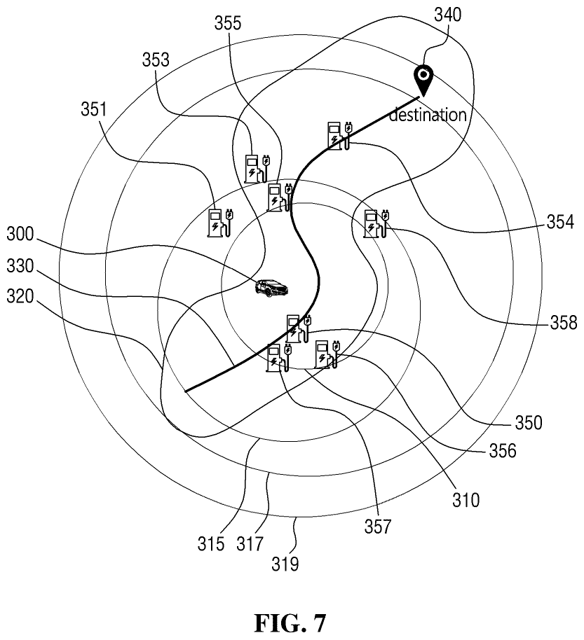

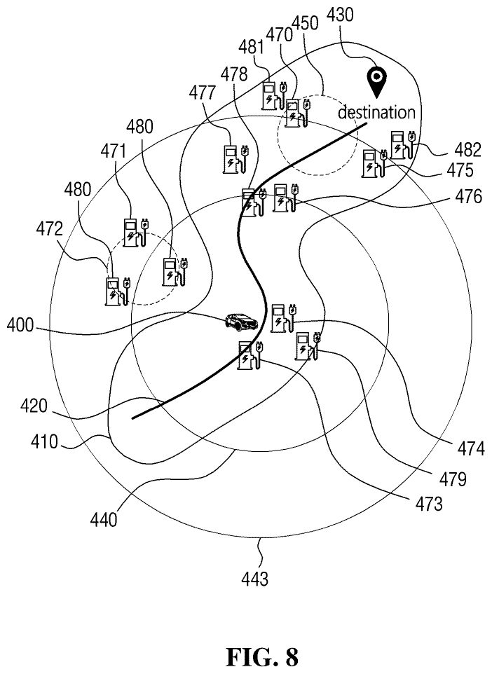

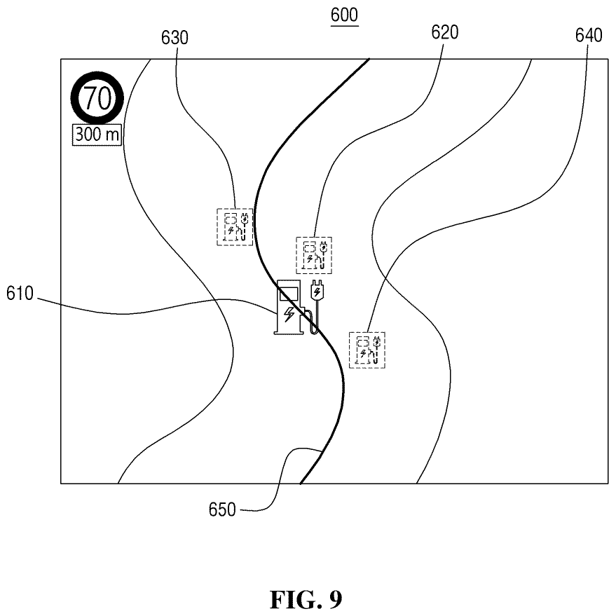

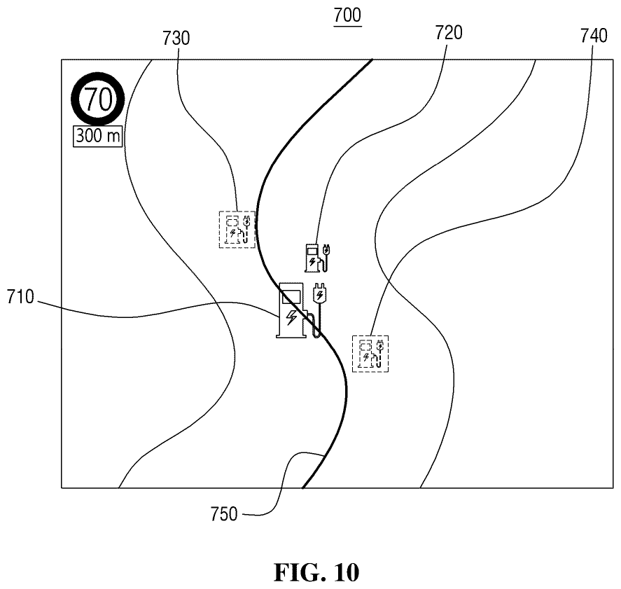

Next, a method for selecting a charging station to be recommended will be described in detail in FIGS. 7 and 8. FIGS. 7 and 8 are illustrative diagrams illustrating a method for obtaining charging stations for each level. A navigation screen providing a service for charging station recommendation will be described later with reference to FIGS. 9 and 10.

As illustrated in FIG. 7, the system for charging station recommendation may obtain distances to empty (DTEs) 319, 317, 315, and 310 based on a charging amount of a mobility apparatus 300 on a route 330 toward a destination 340.

For example, the charging amount of the mobility apparatus 300 is sufficient, such that the destination 340 may be included within the distance to empty (DTE) 319 obtained based on the charging amount. The system for charging station recommendation may end the charging station recommendation when the destination 340 exists within the distance to empty (DTE).

Alternatively, the charging amount of the mobility apparatus 300 is not sufficient, such that the destination 340 may not be included within the distances to empty (DTEs) 317, 315, and 310 obtained based on the charging amount.

The system for charging station recommendation may determine the driving level based on the charging amount of the mobility apparatus 300. The driving level may be determined as level A when the charging amount of the mobility apparatus 300 is greater than or equal to the first reference that is predefined. The system for charging station recommendation that has determined the driving level as level A may select and provide a charging station that does not deviate from the route 330 by a predefined distance 320 or more as a recommended charging station when the destination is not included within the distance to empty (DTE) 317 but the charging amount is sufficient. The charging station recommended by the system for charging station recommendation for the mobility apparatus 300 whose driving level is determined as level A may be a charging station 354 closest to the route 330.

In addition, the driving level may be determined as level B when the charging amount of the mobility apparatus 300 is less than the first reference that is predefined and greater than or equal to the second reference. The system for charging station recommendation that has determined the driving level as level B may obtain all charging stations 353, 351, 350, and 355 included within the distance to empty (DTE) 315. The system for charging station recommendation may obtain all charging stations 353, 351, 350, and 355 included in the distance to empty (DTE) 315 and surrounding data of all charging stations.

The system for charging station recommendation may determine the recommended charging station in consideration of a distance between an existing route 330 and the recommended charging station and a distance between the recommended charging station and the adjacent charging station when it determines the driving level as level B. The charging station recommended by the system for charging station recommendation for the mobility apparatus 300 whose driving level is determined as level B may be the charging station 355 included within the distance to empty (DTE) 315, closest to the route 330, and close to the adjacent charging stations 351 and 353.

In addition, the driving level may be determined as level C when the charging amount of the mobility apparatus 300 is less than the second reference that is predefined. The system for charging station recommendation that has determined the driving level as level C may obtain all charging stations 357, 356, 350, 358, and 355 included within the distance to empty (DTE) 310. The system for charging station recommendation may obtain all charging stations 357, 356, 350, 358, and 355 included in the distance to empty (DTE) 310 and surrounding data of all charging stations.

The system for charging station recommendation may determine the recommended charging station in consideration of a distance between the mobility apparatus 300 and the recommended charging station and routes of the recommended charging station and the adjacent charging station when it determines the driving level as level C. The charging station recommended by the system for charging station recommendation for the mobility apparatus 300 whose driving level is determined as level C may be the charging station 350 included within the distance to empty (DTE) 310, closest to the mobility apparatus 300, and guaranteed to reliably have routes to adjacent charging stations 357 and 356.

Next, as illustrated in FIG. 8, the system for charging station recommendation may obtain distances to empty (DTEs) 440 and 443 based on a charging amount of a mobility apparatus 400 on a route 420 toward a destination 430.

For example, the charging amount of the mobility apparatus 400 is not sufficient, such that the destination 430 may not be included within the distances to empty (DTEs) 440 and 443 obtained based on the charging amount.

The system for charging station recommendation may determine the driving level based on the charging amount of the mobility apparatus 400. The driving level may be determined as level A when the charging amount of the mobility apparatus 400 is greater than or equal to the first reference that is predefined. The system for charging station recommendation that has determined the driving level as level A may select and provide a charging station that does not deviate from the route 420 by a predefined distance 410 or more as a recommended charging station when the destination is not included within the distance to empty (DTE) but the charging amount is sufficient. The charging station recommended by the system for charging station recommendation for the mobility apparatus 400 whose driving level is determined as level A may be a charging station 478 closest to the route 420.

In addition, the driving level may be determined as level B when the charging amount of the mobility apparatus 400 is less than the first reference that is predefined and greater than or equal to the second reference. The system for charging station recommendation that has determined the driving level as level B may obtain all charging stations 470, 475, 476, 477, 478, 471, 480, 474, 473, and 479 included within the distance to empty (DTE) 443. The system for charging station recommendation may obtain all charging stations 470, 475, 476, 477, 478, 471, 480, 474, 473, and 479 included in the distance to empty (DTE) 443 and surrounding data of all charging stations.

The system for charging station recommendation may determine the recommended charging station in consideration of a distance between an existing route 420 and the recommended charging station and a distance between the recommended charging station and the adjacent charging station when it determines the driving level as level B.

For the mobility apparatus 400 whose driving level is determined as level B, the system for charging station recommendation may recommend the charging station 474 included within the distance to empty (DTE) 443, closest to the route 420, and close to an adjacent charging station 479 as a charging station. When a use history of the recommended charging station 474 does not satisfy a reference, the system for charging station recommendation may recommend the charging station 478 included within the distance to empty (DTE) 443, closest to the route 420, and close to an adjacent charging station 476 as a charging station.

When a charger included in the recommended charging station 474 does not satisfy a minimum rapid level reference, the system for charging station recommendation may recommend the charging station 470 included within the distance to empty (DTE) 443, closest to the route 420, and close to an adjacent charging station 481 as a charging station. In this case, the recommended charging station 470 is currently positioned farther from the mobility apparatus 400 than the charging station 475 close to an adjacent charging station 482, but it may be confirmed that the recommended charging system 470 is closer to the route 420 than the charging system 475 from the fact that the recommended charging station 470 is included in a range 450 based on the route 420.

In addition, the driving level may be determined as level C when the charging amount of the mobility apparatus 400 is less than the second reference that is predefined. The system for charging station recommendation that has determined the driving level as level C may obtain all charging stations 478, 474, 479, 473, and 480 included within the distance to empty (DTE) 440. The system for charging station recommendation may obtain all charging stations 478, 474, 479, 473, and 480 included in the distance to empty (DTE) 440 and surrounding data of all charging stations.

The system for charging station recommendation may determine the recommended charging station in consideration of a distance between the mobility apparatus 400 and the recommended charging station and routes of the recommended charging station and the adjacent charging station when it determines the driving level as level C. The charging station recommended by the system for charging station recommendation for the mobility apparatus 400 whose driving level is determined as level C may be the charging station 474 included within the distance to empty (DTE) 440, closest to the mobility apparatus 400, and guaranteed to reliably have a route to adjacent charging station 479.

When there is only one adjacent charging station 479 of the recommended charging station 474 and accordingly, a surrounding data reference is not satisfied, the system for charging station recommendation may recommend the charging station 480 included within the distance to empty (DTE) 440 and close to adjacent charging stations 471 and 480 as a charging station. In this case, the recommended charging station 480 is positioned farther from the route 420 than the charging stations 479 and 473 close to an adjacent charging station 474, but it may be confirmed that adjacent charging stations 471 and 480 are included in one range 472.

Next, the system for charging station recommendation may provide a route for arriving at the recommended charging station to the user through the user device. In this case, the user may receive a route 650 for arriving at a recommended charging station 610 through a navigation screen 600, as illustrated in FIG. 9. The navigation screen 600 may provide the route for arriving at the recommended charging station to the user by making the recommended charging station 610 and the route 650 for arriving at the recommended charging station 610 visible and making adjacent charging stations 620, 630, and 640 invisible. The navigation screen 600 may visually display only the route for arriving at the recommended charging station and the recommended charging station until the user arrives at the recommended charging station.

The system for charging station recommendation may provide a route for arriving at the adjacent charging station to the user through the user device when the recommended charging station is decided to be a charging-impossible charging station.

In this case, as illustrated in FIG. 10, the system for charging station recommendation providing a route 750 for arriving at a recommended charging station 710 through a navigation screen 700 may provide a route for arriving at a second recommended charging station 720 to the user by making the second recommended charging station 720 that is closest to the recommended charging station 710 among adjacent charging stations 720, 730, and 740 and does not deviate from the route by a predefined distance or more visible.

So far, the method for charging station recommendation according to some exemplary embodiments of the present disclosure has been described with reference to FIGS. 1 to 9. The methods according to exemplary embodiments of the present disclosure described so far may be performed by executing a computer program implemented as computer-readable code. The computer program may be transmitted from a first computing apparatus to a second computing apparatus through a network such as the Internet, installed in the second computing apparatus, and thus used in the second computing apparatus. In addition, operations have been illustrated in a specific order in the drawings, but it is not to be understood that the operations should be necessarily performed in the specific order illustrated in the drawings or a sequential order or that all operations illustrated in the drawings should be performed in order to obtain a desired result. In a specific situation, multitasking and parallel processing may be advantageous.

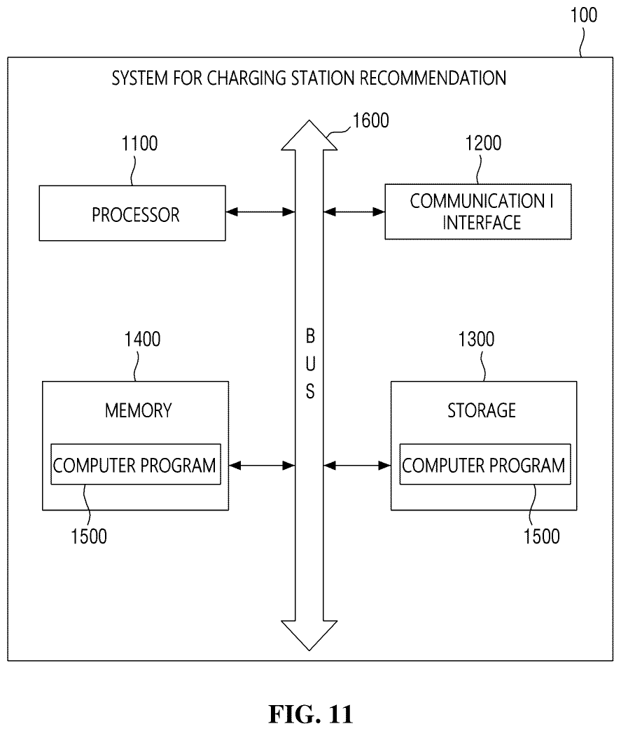

Hereinafter, a hardware configuration of the system for charging station recommendation will be described with reference to FIG. 11. FIG. 11 is a hardware configuration diagram of the system 100 for charging station recommendation according to some exemplary embodiments of the present disclosure. The system 100 for charging station recommendation of FIG. 11 may refer to, for example, the system 100 for charging station recommendation described with reference to FIG. 1. The system 100 for charging station recommendation may include one or more processors 1100, a system bus 1600, a communication interface 1200, a memory 1400 loading a computer program 1500 executed by the processor 1100, and a storage 1300 storing the computer program 1500.

Here, the communication interface 1200 may be connected to an electronic control unit (ECU) of the mobility apparatus 300 described with reference to FIG. 2 through a controller area network (CAN) to receiving driving information of the mobility apparatus 300 in real time.

The processor 1100 controls overall operations of respective components of the system 100 for charging station recommendation. The processor 1100 may perform an arithmetic operation on at least one application or program for executing methods/operations according to various exemplary embodiments of the present disclosure. The memory 1400 stores various data, commands, and/or information. The memory 1400 may load one or more computer programs 1500 from the storage 1300 in order to execute the methods/operations according to various exemplary embodiments of the present disclosure. The system bus 1600 provides a communication function between the components of system 100 for charging station recommendation. The communication interface 1200 supports Internet communication of the system 100 for charging station recommendation. The storage 1300 may non-temporarily store one or more computer programs 1500. The computer program 1500 may include one or more instructions in which the methods/operations according to various exemplary embodiments of the present disclosure are implemented. When the computer program 1500 is loaded into the memory 1400, the processor 1100 may perform the methods/operations according to various exemplary embodiments of the present disclosure by executing the one or more instructions.

In some exemplary embodiments, the system 100 for charging station recommendation described with reference to FIG. 11 may be configured using one or more physical servers included in a server farm based on cloud technology such as a virtual machine. In this case, at least some of the processor 1100, the memory 1400, and the storage 1300 of the components illustrated in FIG. 11 may be virtual hardware, and the communication interface 1200 may also be configured as a virtualized networking element such as a virtual switch.

The computer program 1500 may include instructions for performing an operation of obtaining a charging amount of a mobility apparatus corresponding to a navigation device of the system 100 for charging station recommendation, an operation of obtaining a driving level using the charging amount, an operation of obtaining a charging station existing within a distance to empty (DTE) and surrounding data of the charging station, and an operation of determining a recommended charging station using the driving level and an analysis result of the surrounding data of the charging station and transmitting the determined recommended charging station to a server.

Embodiments of the present disclosure have been described above with reference to FIGS. 1 through 11, but it should be noted that the effects of the present disclosure are not limited to those described above, and other effects of the present disclosure should be apparent from the following description.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those having ordinary skill in the art should appreciate that many variations and modifications can be made to the embodiments without substantially departing from the principles of the present disclosure. Therefore, the disclosed embodiments of the present disclosure are used in a generic and descriptive sense only and not for purposes of limitation.

What is claimed is:

1. A method for recommending a charging station, the method performed by a navigation device and comprising:
obtaining a charging amount of a mobility apparatus;
obtaining a distance to empty (DTE) using the charging amount;
obtaining a driving level using the charging amount;
obtaining a first charging station existing within the DTE and surrounding data of the first charging station; and
determining the first charging station or a second charging station existing within the DTE as a recommended charging station using the driving level and an analysis result of the surrounding data of the first charging station.

2. The method of claim 1, wherein the surrounding data of the first charging station includes adjacent charging station data of the first charging station, and wherein an adjacent charging station of the first charging station is a charging station existing within a predefined distance from the first charging station.

3. The method of claim 1, wherein the obtaining of the DTE using the charging amount includes:
obtaining a destination of the mobility apparatus; and
ending the recommending of the charging station when the destination exists within the DTE.

4. The method of claim 1, wherein the obtaining of the driving level using the charging amount includes:
determining the driving level as level A when the charging amount is greater than or equal to a first reference that is predefined; and
ending the recommending of the charging station.

5. The method of claim 4, wherein the determining of the first charging station or the second charging station existing within the DTE as the recommended charging station using the driving level and the analysis result of the surrounding data of the first charging station includes:
determining the driving level as level B when the charging amount is less than the first reference and greater than or equal to a second reference that is predefined; and
selecting as the recommended charging station from the first charging station or the second charging station which has more rapid chargers and whose last use point in time is closer to an expected use point in time.

6. The method of claim 5, wherein the surrounding data includes distance data between the recommended charging station and an adjacent charging station.

7. The method of claim 5, wherein the surrounding data includes an adjacent charging station of the recommended charging station and route data on a route for arriving at the adjacent charging station on a traveling route of the mobility apparatus.

8. The method of claim 5, wherein the determining of the first charging station or the second charging station existing within the DTE as the recommended charging station using the driving level and the analysis result of the surrounding data of the first charging station includes:
determining the driving level as level C when the charging amount is less than the second reference that is predefined; and
selecting as the recommended charging station from the first charging station and the second charging station whose last use point in time of an adjacent charging station is closer to the expected use point in time.

9. The method of claim 8, wherein the surrounding data includes route data on a route for arriving at an adjacent charging station from the recommended charging station.

10. A method for recommending a charging station, the method performed by a navigation device and comprising:
identifying a re-departure situation of a mobility apparatus after the mobility apparatus arrives at a first charging station;
determining whether or not a charging has been successful when the re-departure situation is identified; and
automatically displaying a recommendation information on an adjacent charging station other than the first charging station when it is determined that charging has not been successful.

11. The method of claim 10, wherein the identifying of the re-departure situation of the mobility apparatus after the mobility apparatus arrives at the first charging station includes obtaining a time when the mobility apparatus has entered a first recommended charging station and a time when the mobility apparatus has exited from the first recommended charging station, and wherein the determining of whether or not the charging has been successful when the re-departure situation is identified includes determining that a charging in the first charging station has been unsuccessful when an interval between the time when the mobility apparatus has entered the first recommended charging station and the time when the mobility apparatus has exited from the first recommended charging station is less than a predefined time.

12. The method of claim 11, wherein the determining of the charging in the first charging station has been unsuccessful when the interval between the time when the mobility apparatus has entered the first recommended charging station and the time when the mobility apparatus has exited from the first recommended charging station is less than the predefined time includes:
obtaining a door opening data of a driver's seat of the mobility apparatus; and
determining that the first charging station is unavailable when a door opening has been sensed between the time when the mobility apparatus has entered the first recommended charging station and the time when the mobility apparatus has exited from the first recommended charging station.

13. The method of claim 11, wherein the identifying of the re-departure situation of the mobility apparatus after the mobility apparatus arrives at the first charging station includes obtaining a charging amount of the mobility apparatus that has entered the first recommended charging station and a charging amount of the mobility apparatus that has exited from the first recommended charging station, and wherein the determining of whether or not the charging has been successful when the re-departure situation is identified includes deciding that charging in the first charging station has been unsuccessful when the charging amount of the mobility apparatus that has entered the first recommended charging station and the charging amount of the mobility apparatus that has exited from the first recommended charging station are the same.

14. The method of claim 11, wherein the automatic displaying of the recommendation information on the adjacent charging station other than the first charging station includes transmitting a fault report for the first recommended charging station to a server.

15. The method of claim 14, wherein the transmitting of the fault report for the first recommended charging station to the server includes:
obtaining a request for selecting the recommendation information on the adjacent charging station other than the first charging station; and
transmitting the fault report for the first recommended charging station to the server when the request for selecting the recommendation information on the adjacent charging station other than the first charging station is obtained.

16. A system for recommending a charging station, comprising:
a communication interface;
a memory into which a computer program is loaded; and
at least one processor to execute the computer program to perform a method comprising:
obtaining a charging amount of a mobility apparatus;
obtaining a distance to empty (DTE) using the charging amount;
obtaining a driving level using the charging amount;
obtaining a first charging station existing within the DTE and surrounding data of the first charging station;
determining the first charging station or a second charging station existing within the DTE as a recommended charging station using the driving level and an analysis result of the surrounding data of the first charging station; and
requesting a route having the recommended charging station as a destination from a server.

17. The system of claim 16, wherein the obtaining the DTE using the charging amount includes:
obtaining the destination of the mobility apparatus; and
ending the recommending of the charging station when the destination exists within the DTE.

18. The system of claim 16, wherein the obtaining the driving level using the charging amount includes:
determining the driving level as level A when the charging amount is greater than or equal to a first reference that is predefined; and
ending the recommending of the charging station.

19. The system of claim 16, wherein the determining the first charging station or the second charging station existing within the DTE as the recommended charging station using the driving level and the analysis result of the surrounding data of the first charging station includes:
determining the driving level as level B when the charging amount is less than the first reference and greater than or equal to a second reference that is predefined; and
selecting as the recommended charging station from the first charging station and the second charging station which has more rapid chargers and whose last use point in time is closer to an expected use point in time.

20. The system of claim 19, wherein the determining the first charging station or the second charging station existing within the DTE as the recommended charging station using the driving level and the analysis result of the surrounding data of the first charging station includes:
determining the driving level as level C when the charging amount is less than the second reference that is predefined; and
selecting as the recommended charging station from the first charging station and the second charging station whose last use point in time of an adjacent charging station is closer to the expected use point in time.
